(19) United States
(12) Patent Application Publication
(10) Pub. No.: US 2019/0207380 A1
(43) Pub. Date: Jul. 4, 2019

(54) Rejection of Capacitive Coupling with RDC Snubber circuit and LED indicators

(71) Applicant: Kenneth Matthew Michaels, Apopka, FL (US)

(72) Inventor: Kenneth Matthew Michaels, Apopka, FL (US)

(21) Appl. No.: 15/860,182

(22) Filed: Jan. 2, 2018

(51) Int. Cl. H02H 3/24; H05B 33/08

(52) U.S. Cl. CPC H02H 3/24; H05B 33/0812

(57) ABSTRACT

The RC-LED Snubber Capacitive Voltage Nullification Circuit can aid in preventing the influence of capacitive voltages, particularly when applied with metering applications in the course of determining the wiring polarity. The use of this circuit can prevent false Correct Wiring conditions and will enhance reliability for other meters that rely on proper wiring for accurate results.

### BACKGROUND

Conventional and present-day 120 VAC outlet testers do not take into account the presence of capacitive voltages that can result due to aging or poorly maintained ac electrical circuit wiring where the hot, neutral, or equipment grounding conductor become loose or ‘open’. Where open connections may exist, particularly in the equipment grounding conductor path, these testers are known to improperly indicate (a) ‘Correct’ wiring conditions when they are not correct or (b) supposed ‘improper’ wiring conditions that are not indicative of the actual wiring condition (correct or otherwise).

The proposed R-C-LED snubber nullification circuit prevents the false indications of any associated testers indicators by rejecting capacitive voltages that could result in an unintended forward-bias or reverse bias of electronic circuitry or provide unintended electromotive forces to illuminate neon or light emitting diode (LED) indicator lamps.

### SUMMARY

The RC-LED Snubber Capacitive Voltage Nullification Circuit can aid in preventing the influence of capacitive voltages, particularly when applied with metering applications in the course of determining the wiring polarity. The use of this circuit can prevent false Correct Wiring conditions and will enhance reliability for other meters that rely on proper wiring for accurate results.

### BRIEF DESCRIPTION OF DRAWING

### (see Replacement Drawing)

Various embodiments of the invention are disclosed in the following detailed description and accompanying drawing.

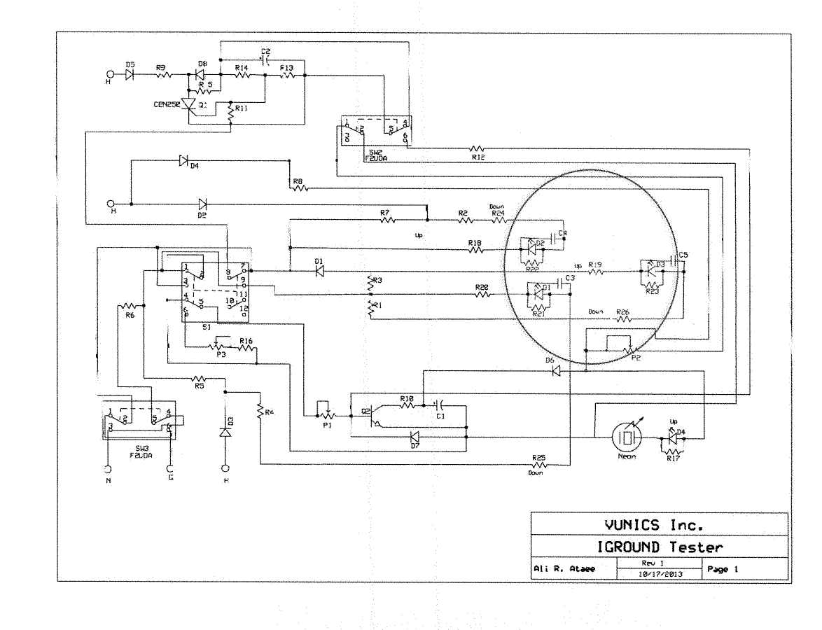

FIG. 1 illustrates the electronic circuit for a 120 VAC circuit tester. The area in the mid- to lower right quadrant of the drawing (bordered in Red) is the particular set of circuitry that is of use to the application.

### DETAILED DESCRIPTION

The primary function of the circuitry is to provide a variation of the RCD snubber circuit, yet using light-emitting diodes instead of conventional zener or transorb diodes. For the use of the instrument schematic, this is called an R-C-LED (resistor-capacitor-diode) snubber rather than an RCD (resistor-capacitor-diode) snubber.

In particular, the capacitors C3, C4, and C5 for each LED (L1, L2, & L3, respectively) are designed to be in parallel to the LED along with resistors R21, R22, and R23, respectively. This differs from the traditional snubber circuit in that they are not in the standard placement at the cathode of the standard diode. The capacitor has four important functions in this regard:
To prevent the forward-biasing of LED's L1, L2, and L3 where unusually high inductance of the ac circuit in which it is connected exists, thus providing more accuracy in the applicable meter's indications.
To maintain the meter's displayed indication during the pulse testing application initiated by other circuitry.
To prevent capacitively-coupled current from forward-biasing the LED's L1, L2, and L3.
To prevent capacitive voltages in a 120 VAC power circuit between ungrounded power conductor and the equipment grounding conductor.

The basic function is as follows:
When the 120 VAC/60 Hz sinusoidal input waveform is increasing through D3 and the capacitor, C3 is uncharged and LED L1 begins to conduct.
Current flows through the LED L1 and begins to charge the capacitor C3.
As the 120 VAC/60 Hz input voltage begins to decrease, L1 no longer conducts.
Capacitor C3/resistor R21 combination is temporarily ‘cut off’ from the rest of the circuit and C3 discharges through R21.
As C3 discharges, the input voltage equals the capacitor voltage, and LED L1 begins conducting again, repeatedly charging the C3 in the process.
The C3/R21 RC circuit combination performs the function of keeping L1 illuminated even though voltage is changing.
The combination of the input resistance (R4 and R25) and the R-C-LED snubber circuit prevents LED L1 from illuminating if the voltage is below 104 VAC.
R20 is connected between the output of the R-C-LED snubber circuit and the Neutral conductor input to prevent capacitive current from erroneously forward-biasing the circuit.
The situation is also repeated for LED's L2 and L3.

### CONCLUSION

The disclosed embodiments are illustrative, not restrictive. While specific configurations of the R-C-LED Snubber Circuit have been described, it is understood that the present invention can be applied to a wide variety of test equipment; including those that measure the quality of ac electrical wiring and meters that depend on the quality of wiring to successfully interpret data that is used to troubleshoot and maintain power systems (e.g., power quality analyzers.) The variances of capacitance within an electrical system can negate the functional properties of all commercially available test equipment whose purpose is to provide true indications of the physical wiring. This disclosure believes that this use of the R-C-LED Snubber Circuit with the specific 100 capacitance/resistor application across the LED is unique in the application.

1. An electrical circuit essentially consisting of capacitors, resistors, and LED's in a parallel configuration to prevent the influence of capacitive voltages that could affect electrical metering necessary to accurately detect 120 VAC wiring conditions.
